(19) United States
(12) Patent Application Publication
(10) Pub. No.: US 2025/0332995 A1
(43) Pub. Date: Oct. 30, 2025

(54) SYSTEMS AND METHODS FOR DETECTING OBSTRUCTIONS IN DRIVER'S VIEW AND PERFORMING REMIDIAL ACTIONS

(71) Applicant: Ford Global Technologies, LLC, Dearborn, MI (US)

(72) Inventors: Andrew Brown, Royal Oak, MI (US); Asa Hattar, Livonia, MI (US); Brendan Diamond, Naples, FL (US); Keith Weston, Canton, MI (US); Anthony Maraldo, Southgate, MI (US); Matthew Flis, Northville, MI (US)

(73) Assignee: Ford Global Technologies, LLC, Dearborn, MI (US)

(21) Appl. No.: 18/646,402

(22) Filed: Apr. 25, 2024

(51) Int. Cl. B60R 1/24; G06F 3/01; G06V 20/59

(52) U.S. Cl. CPC B60R 1/24; G06V 20/597; B60R 2300/30; G06F 3/012; G06F 3/013; G06F 2203/011

(57) ABSTRACT

A vehicle having a detection unit, a vehicle sensor suite, and a processor is disclosed. The detection unit may be configured to capture first inputs associated with a driver's field of view. The vehicle sensor suite may be configured to capture second inputs associated with a geographical area that is obstructed from the driver field of view. The processor may be configured to obtain the first inputs from the detection unit, and determine that the driver's field of view may be obstructed based on the first inputs. The processor may obtain the second inputs associated with the geographical area from a vehicle sensor associated with the vehicle sensor suite, responsive to determining that the driver's field of view is obstructed. The second inputs may include real-time images of the geographical area. The processor may output the real-time images on a display screen in the vehicle.

### FIELD

The present disclosure relates to vehicles and more particularly to systems and methods for detecting obstructions in driver's field of view (FOV) and performing remedial actions when the driver's FOV is obstructed.

### BACKGROUND

While driving a vehicle, a driver's field of view may be occluded in certain scenarios. For example, the vehicle windows may be frosted, the vehicle windows may be covered with snow/mud/fog, the vehicle mirrors may be covered with mud, or the vehicle may have a blind spot. In such scenarios, the driver may face difficulty in driving the vehicle.

Although there exists Advanced Driver Assistance Systems (ADAS) features that assist the driver in such scenarios, such features may be purposely limited or disabled under ideal driving conditions. When driving conditions become less than ideal, drivers may need to quickly turn on the ADAS feature. In certain situations, when visibility is suddenly reduced, it may be difficult for the driver to take their focus off the road and turn on the ADAS feature. Thus, there exists a need for a system and method to effectively assist the driver while driving in such situations.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example environment in which techniques and structures for providing the systems and methods disclosed herein may be implemented.

FIG. 2 depicts a block diagram of an example system for detecting obstructions in driver's field of view and performing remedial actions in accordance with the present disclosure.

FIG. 3 depicts a snapshot of an example display screen in accordance with the present disclosure.

FIG. 4 depicts a flow diagram of an example method for detecting obstructions in driver's field of view and performing remedial actions in accordance with the present disclosure.

### DETAILED DESCRIPTION

### Overview

The present disclosure describes a vehicle configured to detect obstructions in driver's field of view (FOV) and perform remedial actions when the driver's FOV is obstructed. In some aspects, the vehicle may detect that the driver's FOV may be obstructed based on inputs obtained from vehicle sensors (such as a vehicle camera, a microphone, etc.), driver's inputs, inputs from other vehicles moving in proximity to the vehicle in the same direction, and/or the like. In further aspects, the vehicle may predict that the driver's FOV may be obstructed based on additional information, such as weather condition associated with an area in which the vehicle may be moving.

Responsive to determining/predicting that the driver's FOV may be obstructed, the vehicle may determine a geographical area that may be obstructed from the driver's FOV based on the inputs obtained from the vehicle sensors, inputs from other vehicles, etc. The vehicle may then obtain inputs (such as real-time images) associated with the geographical area from a vehicle sensor, and may automatically display the real-time images on a display screen (e.g., a heads-up display (HUD), a panoramic display, or a center stack display) in the vehicle. In some aspects, the vehicle sensor may be a vehicle exterior camera, a vehicle interior camera, a Light Detecting and Ranging (lidar) sensor, or a Radio Detection and Ranging (radar) sensor. In addition or alternatively, the vehicle may obtain such inputs from other vehicles that may be moving in the same direction or from infrastructure sensors using Vehicle-to-Vehicle (V2V) communication, Vehicle-to-Infrastructure (V2I) communication, or vehicle-to-everything (V2X) communication.

In further aspects, the vehicle may be configured to determine an “optimal” or best real-time image to display on the display screen, so that the driver gets to see the best available view on the display screen. To determine the optimal real-time image, the vehicle may further determine parallel “available” view paths to obtain/fetch the real-time images of the geographical area. For example, the vehicle may determine whether the real-time images of the geographical area are available from the vehicle interior camera, the vehicle exterior camera, lidar/radar sensors, and/or from other vehicles moving in the same direction. Responsive to determining the different available view paths, the vehicle may prioritize and/or select the optimal or best view path from the available view paths, and automatically display the real-time images associated with the selected view path on the display screen. In some aspects, the vehicle may select the optimal view path based on a desired driver' FOV, the vehicle trajectory, and/or based on image quality associated with available geographical area's real-time images.

In addition to displaying the real-time images, the vehicle may automatically control vehicle speed, vehicle traction etc., when the driver's FOV may be obstructed. In addition, the vehicle may automatically enable or enhance one or more driver assistance features in such scenarios.

The present disclosure discloses a vehicle that assists the driver when the driver's FOV may be obstructed. The vehicle uses existing vehicle components to determine obstruction presence and to assist the driver, thereby eliminating requirement of using any external systems/servers to perform such operations.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

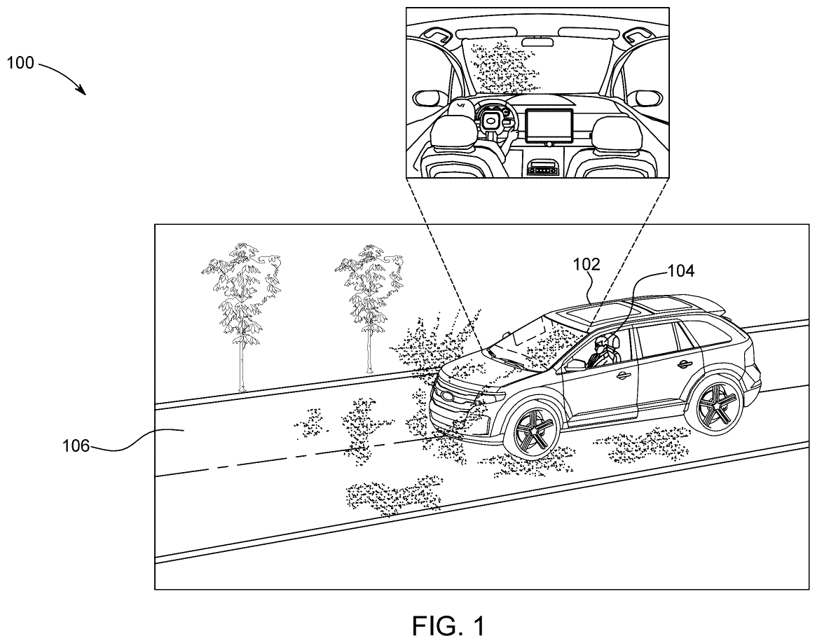

FIG. 1 depicts an example environment 100 in which techniques and structures for providing the systems and methods disclosed herein may be implemented. The environment 100 may include a vehicle 102 that may take the form of any passenger or commercial vehicle such as a car, a work vehicle, a crossover vehicle, a truck, a van, a minivan, a taxi, a bus, etc. The vehicle 102 may be a manually driven vehicle, and/or may be configured to operate in a partially autonomous mode, and may include any powertrain such as a gasoline engine, one or more electrically-actuated motor(s), a hybrid system, etc. A vehicle user 104 (or a driver 104) may be driving the vehicle 102 on a road 106.

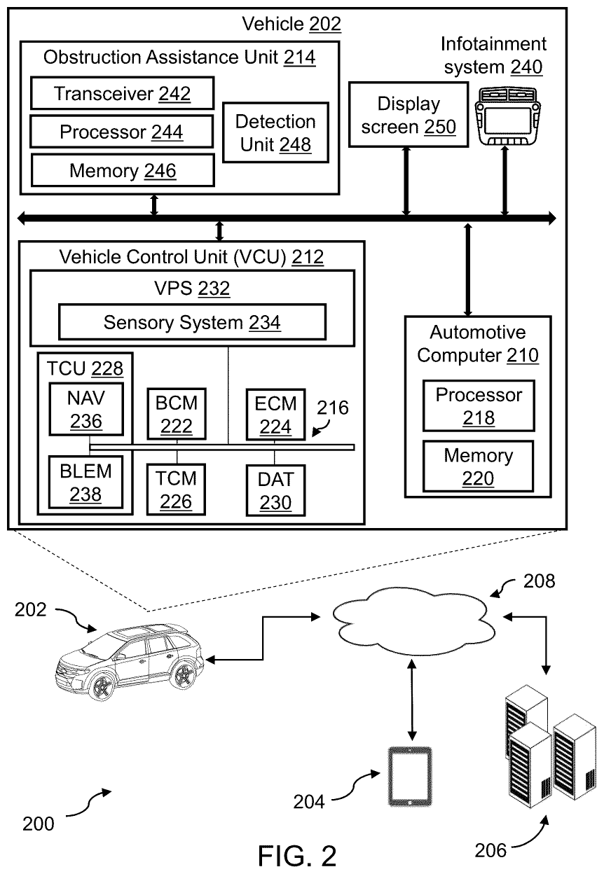

In some aspects, when the vehicle 102 may be traveling on the road 106, a view of a geographical area outside the vehicle 102 may be obstructed from a driver's field of view (FOV) in certain scenarios or when the visibility of the geographical area may be reduced or degraded. For example, the driver's FOV may be obstructed when vehicle windows may be frosted or covered with snow/mud/fog, one or more vehicle mirrors may be covered with mud, or the vehicle 102 may have a blind spot, which may reduce visibility. To facilitate the driver 104 in conveniently navigating the road 106 in such situations, the vehicle 102 may include an obstruction assistance unit (shown as obstruction assistance unit 214 in FIG. 2).

In some aspects, the obstruction assistance unit (“unit”) may be configured to detect/monitor presence of an obstruction in the driver's FOV or monitor exterior visibility (e.g., degraded/low/no visibility instances) to detect the obstruction. When the unit determines that the driver's FOV may be obstructed, the unit may perform one or more remedial actions to assist the driver 104 in conveniently navigating the road 106 in such situations. In some aspects, the unit may detect an obstruction presence in the driver's FOV “reactively” by using inputs obtained from a vehicle sensor suite (e.g., a vehicle interior camera, a vehicle exterior camera, a microphone, etc.), driver inputs, or by using inputs obtained from other vehicles via Vehicle-to-Vehicle (V2V) communication, or from infrastructure via Vehicle-to-Infrastructure (V2I) communication or vehicle-to-everything (V2X) communication, etc. As an example, the unit may determine a distress level associated with the driver 104 and/or driver's movement in a vehicle interior portion (such as driver's head movement or driver's eye movement) based on driver images captured by the vehicle interior camera, and may determine that the driver's FOV may be obstructed based on the detected distress level and/or the driver's movement. As another example, the unit may determine that the driver's FOV may be obstructed when visibility in the driver's FOV (as detected based on images captured by the vehicle exterior camera) may be less than a threshold value. In other aspects, the unit may detect the obstruction presence in the driver's FOV “proactively” by predicting the obstruction presence based on information associated with weather conditions (e.g., storm/unideal conditions), geofenced data of predetermined geographical areas (including the geographical area described above), and/or the like. The geofenced data may include specific information associated with the geographical area, e.g., whether the area has sand, dust, snow, etc., whether the area is a desert area, whether a planned construction work is ongoing in the area, and/or the like.

Responsive to the detection/prediction of the obstruction presence in the driver's FOV, the unit may perform one or more remedial actions. For example, the unit may obtain/fetch information (such as real-time images) associated with the geographical area that is obstructed from the driver's FOV from a vehicle sensor suite (shown as vehicle sensory system 234 in FIG. 2) or from the other vehicles moving in the same direction and in proximity to the vehicle 102, and automatically display the real-time images on a display screen (shown as display screen 250 in FIG. 2) in the vehicle 102. The display screen may include, but is not limited to, a heads-up display, a panoramic display, a center stack display or a screen associated with vehicle's infotainment system (shown as infotainment system 240 in FIG. 2). The driver 104 may view the real-time images of the geographical area on the display screen, and may hence conveniently drive the vehicle 102 on the road 106 even when the driver's FOV may be obstructed.

In some aspects, the unit may be further configured to determine an “optimal” or best real-time image to display on the display screen, so that the driver 104 gets to see the best available view on the display screen. To determine the optimal real-time image, the unit may further determine parallel “available” view paths to obtain/fetch the real-time images of the geographical area that is obstructed from the driver's FOV. Stated another way, the unit may determine different ways to obtain the real-time images of the geographical area, or the unit may determine available views of the geographical area from the vehicle sensor suite. For example, the unit may determine whether the real-time images of the geographical area are available from the vehicle interior camera, the vehicle exterior camera, lidar/radar sensors, and/or from other vehicles moving in the same direction. Responsive to determining the different available view paths, the unit may prioritize and/or select the optimal or best view path from the available view paths, and automatically display the real-time images associated with the selected view path on the display screen. In some aspects, the unit may select the optimal view path based on a desired driver' FOV, the vehicle trajectory, and/or based on image quality associated with geographical area's real-time images available from the vehicle interior camera, the vehicle exterior camera, lidar/radar sensors, and/or from other vehicles. In further aspect, the unit may prioritize and/or select the optimal view path based on the detected distress level and/or the driver's movement in the vehicle interior portion.

In addition to displaying the real-time images, the unit may automatically control/update one or more vehicle parameters such as vehicle traction, vehicle speed, etc., responsive to determining that the driver's FOV may be obstructed. For example, the unit may automatically reduce the vehicle speed when the driver's FOV may be obstructed. In addition, the unit may automatically enable or enhance one or more driver assistance features in such situations. Further, the unit may output an audible alert and/or a visual alert on the infotainment system, responsive to determining that the driver's FOV may be obstructed. The driver 104 may perform appropriate actions (e.g., reduce vehicle speed, stop the vehicle 102, and/or the like) responsive to hearing/viewing the alert. In this manner, the vehicle 102 may indicate the obstruction presence (or reduced visibility) to the driver 104 in a timely manner, so that the driver 104 may take appropriate actions on time.

Further vehicle details are described below in conjunction with FIG. 2.

The vehicle 102 and/or the driver 104 implement and/or perform operations, as described here in the present disclosure, in accordance with the owner manual and safety guidelines. In addition, any action taken by the driver 104 based on the notifications/alerts provided by the vehicle 102 should comply with all the rules specific to the location and operation of the vehicle 102 (e.g., Federal, state, country, city, etc.). The notifications/alerts, as provided by the vehicle 102, should be treated as suggestions and only followed according to any rules specific to the location and operation of the vehicle 102.

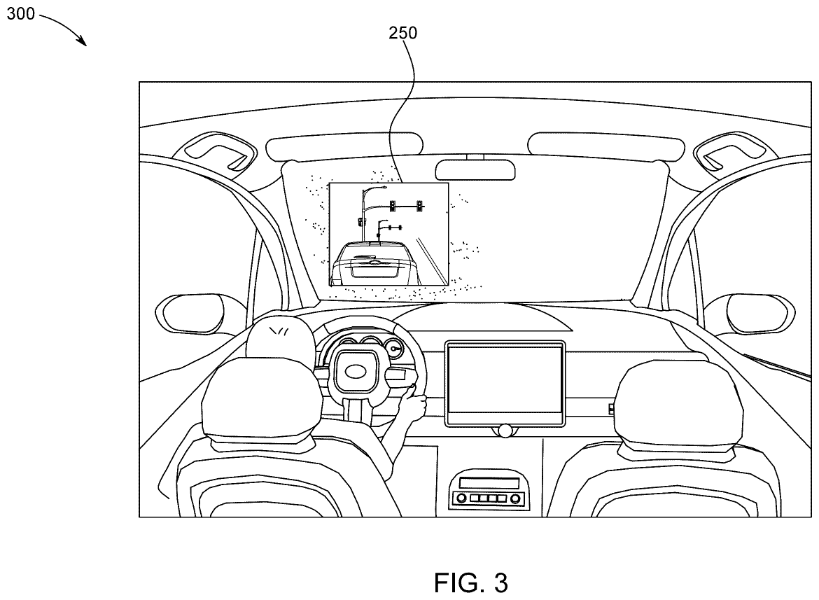

FIG. 2 depicts a block diagram of an example system 200 for detecting obstructions in driver's FOV and performing remedial actions in accordance with the present disclosure. While describing FIG. 2, references will be made to FIG. 3. FIG. 3 depicts a snapshot 300 of a display screen in accordance with the present disclosure.

The system 200 may include a vehicle 202, a user device 204, and one or more servers 206 communicatively coupled with each other via one or more networks 208. The vehicle 202 may be same as the vehicle 102 described above in conjunction with FIG. 1. The user device 204 may be associated with the driver 104, and may include, but is not limited to, a mobile phone, a laptop, a computer, a tablet, a wearable device, or any other similar device with communication capabilities. The server(s) 206 may be part of a cloud-based computing infrastructure and may be associated with and/or include a Telematics Service Delivery Network (SDN) that provides digital data services to the vehicle 202 and other vehicles (not shown in FIG. 2) that may be part of a vehicle fleet. In further aspects, the server(s) 206 may store information associated with weather conditions and/or geofenced data of the geographical area. The server 206 may transmit such information to the vehicle 202 at a predefined frequency or when the vehicle 202 transmits a request to the server 206 to provide such information.

The network(s) 208 illustrates an example communication infrastructure in which the connected devices discussed in various embodiments of this disclosure may communicate. The network(s) 208 may be and/or include the Internet, a private network, public network or other configuration that operates using any one or more known communication protocols such as, for example, transmission control protocol/Internet protocol (TCP/IP), Bluetooth®, Bluetooth Low Energy (BLE), Wi-Fi based on the Institute of Electrical and Electronics Engineers (IEEE) standard 802.11, ultra-wideband (UWB), and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

The vehicle 202 may include a plurality of units including, but not limited to, an automotive computer 210, a Vehicle Control Unit (VCU) 212, and an obstruction assistance unit 214. The VCU 212 may include a plurality of Electronic Control Units (ECUs) 216 disposed in communication with the automotive computer 210.

The user device 204 may connect with the automotive computer 210 and/or the obstruction assistance unit 214 via the network 208, which may communicate via one or more wireless connection(s), and/or may connect with the vehicle 202 directly by using near field communication (NFC) protocols, Bluetooth® protocols, Wi-Fi, Ultra-Wide Band (UWB), and other possible data connection and sharing techniques.

In some aspects, the automotive computer 210 and/or the obstruction assistance unit 214 may be installed anywhere in the vehicle 202, in accordance with the disclosure. Further, the automotive computer 210 may operate as a functional part of the obstruction assistance unit 214. The automotive computer 210 may be or include an electronic vehicle controller, having one or more processor(s) 218 and a memory 220. Moreover, the obstruction assistance unit 214 may be separate from the automotive computer 210 (as shown in FIG. 2) or may be integrated as part of the automotive computer 210.

The processor(s) 218 may be disposed in communication with one or more memory devices disposed in communication with the respective computing systems (e.g., the memory 220 and/or one or more external databases not shown in FIG. 2). The processor(s) 218 may utilize the memory 220 to store programs in code and/or to store data for performing aspects in accordance with the disclosure. The memory 220 may be a non-transitory computer-readable memory storing an obstruction assistance program code. The memory 220 can include any one or a combination of volatile memory elements (e.g., dynamic random-access memory (DRAM), synchronous dynamic random-access memory (SDRAM), etc.) and can include any one or more nonvolatile memory elements (e.g., erasable programmable read-only memory (EPROM), flash memory, electronically erasable programmable read-only memory (EEPROM), programmable read-only memory (PROM), etc.).

In accordance with some aspects, the VCU 212 may share a power bus with the automotive computer 210 and may be configured and/or programmed to coordinate the data between vehicle systems, connected servers (e.g., the server(s) 206), and other vehicles (not shown in FIG. 2) operating as part of a vehicle fleet. The VCU 212 can include or communicate with any combination of the ECUs 216, such as a Body Control Module (BCM) 222, an Engine Control Module (ECM) 224, a Transmission Control Module (TCM) 226, a telematics control unit (TCU) 228, a Driver Assistances Technologies (DAT) controller 230, etc. The VCU 212 may further include and/or communicate with a Vehicle Perception System (VPS) 232, having connectivity with and/or control of one or more vehicle sensory system(s) 234. The vehicle sensory system 234 may include one or more vehicle sensors including, but not limited to, a Radio Detection and Ranging (radar) sensor configured for detection and localization of objects inside and outside the vehicle 202 using radio waves, sitting area buckle sensors, sitting area sensors, a Light Detecting and Ranging (lidar) sensor, door sensors, proximity sensors, temperature sensors, wheel sensors, ambient weather sensors, vehicle internal and external cameras, steering wheel sensors, microphone, etc. In some aspects, the vehicle sensory system 234 (or “vehicle sensor suite”) may capture information associated with a geographical area that may be obstructed from the driver's FOV. For example, the vehicle interior/exterior camera may capture real-time camera views of the geographical area that may be obstructed from the driver's FOV, and radar/lidar sensor may generate augmented reality-based rendering to help translate the sensed viewpoints into a 3D visual world that is easily perceptible to the driver 104.

In some aspects, the VCU 212 may control vehicle operational aspects and implement one or more instruction sets received from the user device 204, from one or more instruction sets stored in the memory 220, including instructions operational as part of the obstruction assistance unit 214. For example, the VCU 212 may be configured to control vehicle parameters such as vehicle traction, vehicle speed, etc., based on the instructions/signals obtained from the obstruction assistance unit 214.

The TCU 228 may be configured and/or programmed to provide vehicle connectivity to wireless computing systems onboard and off board the vehicle 202, and may include a Navigation (NAV) receiver 236 for receiving and processing a GPS signal, a BLE Module (BLEM) 238, a Wi-Fi transceiver, a UWB transceiver, and/or other wireless transceivers (not shown in FIG. 2) that may be configurable for wireless communication (including cellular communication) between the vehicle 202 and other systems (e.g., a vehicle key fob, not shown in FIG. 2), computers, and modules. The TCU 228 may be disposed in communication with the ECUs 216 by way of a bus. In some aspects, the TCU 228 may be configured to communicatively couple with other vehicles via Vehicle-to-Vehicle (V2V) communication, and/or with infrastructure sensors via Vehicle-to-Infrastructure (V2I) communication or vehicle-to-everything (V2X) communication, and exchange information (e.g., the real-time images of the geographical area in the driver's FOV) with the other vehicles and/or the infrastructure sensors. In some aspects, the obstruction assistance unit 214 may use this information to detect and/or predict the obstruction presence in the driver's FOV.

The ECUs 216 may control aspects of vehicle operation and communication using inputs from human drivers, inputs from an autonomous vehicle controller, the obstruction assistance unit 214, and/or via wireless signal inputs received via the wireless connection(s) from other connected devices, such as the user device 204, the server(s) 206, among others.

The BCM 222 generally includes integration of sensors, vehicle performance indicators, and variable reactors associated with vehicle systems, and may include processor-based power distribution circuitry that can control functions associated with the vehicle body such as lights, windows, security, camera(s), audio system(s), speakers, wipers, door locks and access control, and various comfort controls. The BCM 222 may also operate as a gateway for bus and network interfaces to interact with remote ECUs (not shown in FIG. 2).

The DAT controller 230 may provide Level-1 through Level-3 automated driving and driver assistance functionality that can include, for example, active parking assistance, vehicle backup assistance, adaptive cruise control, among other features. The DAT controller 230 may also provide aspects of user and environmental inputs usable for user authentication.

In some aspects, the automotive computer 210 may connect with an infotainment system 240. The infotainment system 240 may include a touchscreen interface portion, and may include voice recognition features, biometric identification capabilities that can identify users based on facial recognition, voice recognition, fingerprint identification, or other biological identification means. In other aspects, the infotainment system 240 may be further configured to receive user instructions via the touchscreen interface portion, and/or display notifications (including visual alert notifications), navigation maps, etc. on the touchscreen interface portion.

The computing system architecture of the automotive computer 210, the VCU 212, and/or the obstruction assistance unit 214 may omit certain computing modules. It should be readily understood that the computing environment depicted in FIG. 2 is an example of a possible implementation according to the present disclosure, and thus, it should not be considered limiting or exclusive.

In accordance with some aspects, the obstruction assistance unit 214 may be integrated with and/or executed as part of the ECUs 216. The obstruction assistance unit 214, regardless of whether it is integrated with the automotive computer 210 or the ECUs 216, or whether it operates as an independent computing system in the vehicle 202, may include a transceiver 242, a processor 244, a computer-readable memory 246, and a detection unit 248, which are communicatively coupled with each other. In some aspects, the obstruction assistance unit 214 may be communicatively coupled with a display screen 250. The display screen 250 may be a Heads-Up Display (HUD), a Panoramic display, a center stack display, or a screen associated with the infotainment system 240. The display screen 250 may be configured to display real-time images of the geographical area, as described above.

The transceiver 242 may be configured to receive information/inputs from one or more external devices or systems, e.g., the user device 204, the server(s) 206, and/or the like via the network 208. Further, the transceiver 242 may transmit notifications (e.g., alert/alarm signals) to the external devices or systems. In addition, the transceiver 242 may be configured to receive information/inputs from vehicle components such as the infotainment system 240, the vehicle sensory system 234 (including the vehicle interior/exterior cameras, radar, lidar, etc.), the detection unit 248, and/or the like. Further, the transceiver 242 may transmit notifications (e.g., alert/alarm signals) to the vehicle components such as the infotainment system 240, the BCM 222, the display screen 250, etc.

The processor 244 and the memory 246 may be same as or similar to the processor 218 and the memory 220, respectively. In some aspects, the processor 244 may utilize the memory 246 to store programs in code and/or to store data for performing aspects in accordance with the disclosure. The memory 246 may be a non-transitory computer-readable medium or memory storing the obstruction assistance program code. In some aspects, the memory 246 may additionally store information associated with the vehicle 202 and one or more sensory inputs received from the vehicle sensory system 234. In additional aspects, the memory 246 may store one or more AI based image processing algorithms that may facilitate the processor 244 to analyze the images obtained from the vehicle cameras (associated with the vehicle sensory system 234), and identify best quality camera image using machine learning based quality assessments. For example, the processor 244 may compare the images captured by the vehicle cameras with pre-stored camera images (e.g., training data associated with a plurality of images), and identify the best quality image based on the comparison.

The detection unit 248 may be configured to capture inputs (e.g., “first inputs”) associated with the driver's FOV from inside the vehicle 202. In some aspects, the detection unit 248 may be part of a vehicle sensor suite or the vehicle sensory system 234 that includes an exterior sensor suite (such as the vehicle exterior camera), an interior sensor suite (such as the vehicle interior camera, the microphone, etc.), and/or the like. In some aspects, the detection unit 248 may capture driver's images in a vehicle interior portion while driving the vehicle 102 (e.g., using vehicle interior camera, other vehicle sensors). In addition or alternatively, the detection unit 248 may capture driver's movement such as driver's head movement and/or driver's eye movement (e.g., using vehicle interior camera).

In further aspects, the detection unit 248 may include a user input device (such as the display screen 250, the infotainment system 240, a push button on a vehicle dashboard, etc.) configured to receive/capture user inputs indicating that the driver's FOV may be obstructed. In additional aspects, the detection unit 248 may include the TCU 228 that may be configured to obtain inputs associated with the driver's FOV from other vehicles moving in the same direction and in proximity to the vehicle 202 via V2V communication, and/or from one or more infrastructure sensors via V2I/V2X communication, as described above.

In operation, the processor 244 may obtain the first inputs from the detection unit 248 and may determine that the driver's FOV may be obstructed based on the first inputs. For instance, the processor 244 may obtain the driver's images in the vehicle interior portion from the detection unit 248 (e.g., vehicle interior camera), and may determine driver's distress level based on the driver's images. In some aspects, the processor 244 may determine that the driver's FOV (or desired FOV) may be obstructed when the driver's distress level may be greater than a first threshold value. In addition or alternatively, the processor 244 may determine driver's movement such as driver's head movement and/or driver's eye movement based on the inputs obtained from the detection unit 248 (e.g., vehicle interior camera), and may determine that the driver's FOV (or desired FOV) may be obstructed when the driver's movement over a predefined time-period is greater than a threshold value. For example, when the driver 104 is frequently turning driver's head towards right or left side, the processor 244 may determine that the driver's FOV may be obstructed and may need assistance. The detection of the distress level/driver's movement may be required in determining whether the driver's FOV is obstructed. This is because if the driver 104 is attempting to view something that the driver 104 cannot see due to an obstructed FOV, some level of distress and/or movement of the driver's head and/or eyes can be detected, thereby indicating that the driver's FOV may be obstructed.

In addition, the processor 244 may obtain inputs from the vehicle sensor suite (e.g., from the vehicle interior camera), analyze visibility through exterior windows, and determine if the driver 104 may be able to see outward (or whether the visibility is greater than or less than a threshold value). The processor 244 may determine that the driver's FOV may be obstructed when visibility in the driver FOV may be less than the threshold value.

In further aspects, the processor 244 may obtain the user inputs (indicating that the driver's FOV is obstructed), and may determine that the driver's field of view may be obstructed based on the user inputs. In further aspects, the processor 244 may obtain the first inputs from other vehicles, via the detection unit 248, and may determine that the driver's field of view may be obstructed based on the obtained inputs.

In further aspects, the processor 244 may be obtain inputs/information associated with weather conditions and/or geofenced data of one or more predetermined areas (including the geographical area described above) from the server 206 (or any other device), and determine that the driver's FOV may be obstructed based on the obtained inputs. In some aspects, the processor 244 may “predict” that the driver's FOV may be obstructed based on the obtained inputs described above. For example, the processor 244 may predict that the driver's FOV may be obstructed when the vehicle 202 may be traveling through a geographical area that is predicted to have snow or thunderstorm (determined based on the obtained information associated with weather conditions).

Responsive to determining/predicting that the driver's FOV may be obstructed, the processor 244 may identify a geographical area that may be obstructed from the driver's FOV. In some aspects, the processor 244 may identify the geographical area based on the first inputs obtained from the detection unit 248. For example, the processor 244 may determine that the geographical area in front of the vehicle 102 may be obstructed from the driver's FOV, when the driver's body movement and/or eye movement (as determined via images captured by the vehicle interior camera) indicate that the driver 104 may be frequently tilting towards right or left, and the driver's eyes may be trying to view the geographical area in front of the vehicle 102 when the driver's body tilts. In some aspects, the identified geographical area may be part of the “desired FOV” for the driver 104 (that the processor 244 identifies based on the first inputs obtained from the detection unit 248, as described above).

Responsive to identifying the geographical area that may be occluded from the driver's FOV, the processor 244 may perform one or more remedial actions to enable the driver 104 to conveniently drive the vehicle 202. In some aspects, to perform the remedial actions, the processor 244 may obtain one or more inputs (or “second inputs”) associated with the identified geographical area (e.g., the area in front of the vehicle 202) from a vehicle sensor of the vehicle sensor suite/vehicle sensory system 234. The vehicle sensor may be a vehicle exterior camera, a vehicle interior camera, a lidar sensor, a radar sensor, etc. The second inputs may include real-time images of the identified geographical area (such as camera views or augmented reality based rendering) that may be captured by the vehicle sensor. In further aspects, the processor 244 may obtain the second inputs from other vehicles and/or infrastructure sensors using V2V, V2I, or V2X communication. The processor 244 may be further configured to automatically output/display the real-time images on the display screen 250 (as shown in the snapshot 300 of FIG. 3), which may facilitate the driver 104 to view the geographical area that may be obstructed in the driver's FOV.

In some aspects, the processor 244 may cause the display screen 250 to display the optimal or “best available” real-time image, so that the driver 104 may get the best driving experience. To determine the best available real-time image, the processor 244 may first determine available view paths to capture/obtain the second inputs (e.g., real-time images) associated with the geographical area, when the driver's FOV may be obstructed. The available view paths may be associated with the vehicle sensor suite, which may include an interior camera vision based view path, an exterior camera vision based view path, a radar/lidar sensor vision based view path, and/or the other. Stated another way, the processor 244 may determine whether the real-time images of the geographical area are available from the vehicle interior camera, the vehicle exterior camera, and/or the lidar/radar sensors. In some aspects, the processor 244 may determine the vehicle trajectory, and determine the available view paths based on the vehicle trajectory. For example, the processor 244 may determine that the second inputs may be available from the front exterior camera when the vehicle 202 may be moving straight. Similarly, the processor 244 may determine that the second inputs may be available from the front and side cameras when the vehicle 202 may be turning. In addition, the processor 244 may determine whether the real-time images are available from other vehicles moving in the same direction and/or from infrastructure sensors.

Responsive to determining the different available view paths, the processor 244 may prioritize and/or select a best view path from the available view paths, and display the real-time images associated with the selected best view path on the display screen 250. In some aspects, the processor 244 may select the best view path based on a desired driver' FOV and vehicle trajectory. In some aspects, the processor 244 may determine the desired FOV based on driver's movement, such as driver's head movement and/or driver's eye movement. In addition or alternatively, the processor 244 may select the best view path based on image quality of the available view paths. In some aspects, the processor 244 may determine the best view path based on locations of one or more vehicle sensors. For example, the processor 244 may determine locations of different vehicle cameras, and identify a camera whose location may be best situated in the direction of the desired FOV, to determine the best view path. Responsive to such determination, the processor 244 may select the vehicle camera and automatically display the real-time images captured by the selected vehicle camera on the display screen 250. This may enable the driver 104 to view the desired FOV in an optimal manner, when the driver's FOV may be obstructed or when there may be reduced visibility.

In addition to displaying the real-time images, the processor 244 may automatically control one or more vehicle parameters such as vehicle traction, vehicle speed, etc. In addition, the processor 244 may automatically enable or enhance one or more driver assistance features. For example, the processor 244 may temporarily re-enable certain driver assistance features that may have been disabled by the driver 104 before the driver's FOV got obstructed. Further, the processor 244 may output an audible alert and/or a visual alert on the infotainment system 240, in addition to displaying the real-time images on the display screen 250. The driver 104 may perform appropriate actions (e.g., decrease vehicle speed, stop the vehicle 102, and/or the like) responsive to hearing/viewing the alert. In this manner, the vehicle 102 indicates the obstruction presence to the driver 104 in a timely manner, so that the driver 104 may perform appropriate actions. In addition, the processor 244 may actively take vehicular actions to prevent vehicle movement in certain geographical areas in which the visibility may be expected to be low. For example, the processor 244 may change travel route to circumvent such areas, recommend to maintain a certain distance from other vehicles while moving in such areas, and/or the like.

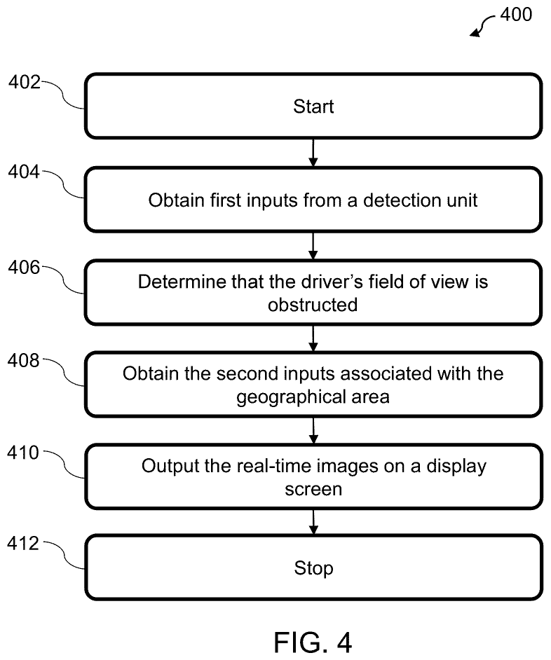

FIG. 4 depicts a flow diagram of an example method 400 for detecting obstructions in the driver's FOV and performing remedial actions in accordance with the present disclosure. FIG. 4 may be described with continued reference to prior figures. The following process is exemplary and not confined to the steps described hereafter. Moreover, alternative embodiments may include more or less steps that are shown or described herein and may include these steps in a different order than the order described in the following example embodiments.

The method 400 starts at step 402. At step 404, the method 400 may include obtaining, by the processor 244, the first inputs from the detection unit 248. At step 406, the method 400 may include determining, by the processor 244, that the driver's FOV may be obstructed based on the first inputs. At step 408, the method 400 may include obtaining, by the processor 244, the second inputs associated with the geographical area from a vehicle sensor of the vehicle sensor suite, responsive to determining that the driver's FOV may be obstructed. The second inputs may include real-time images associated with the geographical area. At step 410, the method 400 may include outputting, by the processor 244, the real-time images on the display screen 250.

The method 400 may end at step 412.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A vehicle comprising:
a detection unit configured to capture first inputs associated with a driver's field of view;
a vehicle sensor suite configured to capture second inputs associated with a geographical area that is obstructed from the driver field of view; and
a processor communicatively coupled with the detection unit and the vehicle sensor suite, wherein the processor is configured to:
obtain the first inputs from the detection unit;
determine that the driver's field of view is obstructed based on the first inputs;
obtain the second inputs associated with the geographical area from a vehicle sensor associated with the vehicle sensor suite, responsive to determining that the driver's field of view is obstructed, wherein the second inputs comprise real-time images of the geographical area; and
output the real-time images on a display screen in the vehicle.

2. The vehicle of claim 1, wherein the vehicle sensor suite comprises a vehicle exterior camera, a vehicle interior camera, a Light Detecting and Ranging (lidar) sensor, and a Radio Detection and Ranging (radar) sensor.

3. The vehicle of claim 2, wherein the real-time images comprise camera views or augmented reality-based rendering.

4. The vehicle of claim 1, wherein the processor is further configured to:
determine a plurality of available view paths to capture the second inputs associated with the geographical area, wherein the plurality of available view paths is associated with the vehicle sensor suite;
select an optimal view path from the plurality of available view path; and
select the vehicle sensor from the vehicle sensor suite based on the selection of the optimal view path.

5. The vehicle of claim 4, wherein the plurality of available view paths comprises: an interior camera vision based view path, an exterior camera vision based view path, and a radar sensor or lidar sensor based view path.

6. The vehicle of claim 4, wherein the processor is further configured to:
determine a vehicle trajectory and a desired field of view responsive to determining that the driver's field of view is obstructed; and
select the optimal view path based on the vehicle trajectory and the desired field of view.

7. The vehicle of claim 6, wherein the processor is further configured to determine the desired field of view based on at least one of a driver's head movement or a driver's eye movement.

8. The vehicle of claim 4, wherein the processor is further configured to select the optimal view path based on an image quality associated with each available view path of the plurality of available view paths.

9. The vehicle of claim 1, wherein the detection unit comprises a vehicle interior camera configured to capture driver's images in a vehicle interior portion, and wherein the processor is further configured to:
determine that a driver is distressed or a driver movement is greater than a predefined movement threshold based on the driver's images; and
determine that the driver's field of view is obstructed responsive to determining that the driver is distressed or the driver movement is greater than the predefined movement threshold.

10. The vehicle of claim 9, wherein the driver's movement comprises at least one of a driver's head movement or a driver's eye movement.

11. The vehicle of claim 1, wherein the detection unit comprises a user input device configured to receive user inputs indicating that the driver's field of view is obstructed, and wherein the processor is further configured to determine that the driver's field of view is obstructed based on the user inputs.

12. The vehicle of claim 1, wherein the detection unit comprises a vehicle telematics control unit configured to capture the first inputs from other vehicles using a Vehicle-to-Vehicle (V2V) communication, a Vehicle-to-Infrastructure (V2I) communication, or a vehicle-to-everything (V2X) communication.

13. The vehicle of claim 1, wherein the processor is further configured to configured to:
obtain information associated with at least one of weather conditions or geofenced data of the geographical area; and
determine that the driver's field of view is obstructed based on the information.

14. The vehicle of claim 1, wherein the processor is further configured to determine that the driver's field of view is obstructed when visibility in the driver field of view is less than a predefined threshold value.

15. The vehicle of claim 1, wherein the processor is further configured to perform a remedial action responsive to determining that the driver's field of view is obstructed.

16. The vehicle of claim 15, wherein the remedial action comprises controlling a vehicle traction.

17. The vehicle of claim 15, wherein the remedial action comprises enabling or enhancing a driver assistance feature.

18. The vehicle of claim 1, wherein the display screen comprises a heads-up display (HUD), a panoramic display, or a center stack display.

19. A method comprising:
obtaining, by a processor, first inputs from a detection unit configured to capture first inputs associated with a driver's field of view;
determining, by the processor, that the driver's field of view is obstructed based on the first inputs;
obtaining, by the processor, second inputs associated with a geographical area from a vehicle sensor associated with a vehicle sensor suite, responsive to determining that the driver's field of view is obstructed, wherein the second inputs comprise real-time images of the geographical area, and wherein the vehicle sensor suite is configured to capture the second inputs associated with the geographical area that is obstructed from the driver field of view; and
outputting, by the processor, the real-time images on a display screen in a vehicle.

20. A non-transitory computer-readable storage medium having instructions stored thereupon which, when executed by a processor, cause the processor to:
obtain first inputs from a detection unit configured to capture first inputs associated with a driver's field of view;
determine that the driver's field of view is obstructed based on the first inputs;
obtain second inputs associated with a geographical area from a vehicle sensor associated with a vehicle sensor suite, responsive to determining that the driver's field of view is obstructed, wherein the second inputs comprise real-time images of the geographical area, and wherein the vehicle sensor suite is configured to capture the second inputs associated with the geographical area that is obstructed from the driver field of view; and
output the real-time images on a display screen in a vehicle.
